(19) United States
(12) Patent Application Publication
(10) Pub. No.: US 2010/0012638 A1
(43) Pub. Date: Jan. 21, 2010

(54) TIG Braze-Welding With Metal Transfer In Drops At A Controlled Frequency

(75) Inventors: Jean-Marie Fortain, Osny (FR); Olivier Revel, Pierrelaye (FR)

Correspondence Address: AIR LIQUIDE;Intellectual Property, 2700 POST OAK BOULEVARD, SUITE 1800, HOUSTON, TX, 77056, US

(73) Assignee: Air Liquide Welding France, Paris (FR)

(21) Appl. No.: 12/375,318

(22) PCT Filed: Jul. 12, 2007
(86) PCT No.: PCT/FR07/51648

§ 371 Date: Sep. 16, 2009

(30) Foreign Application Priority Data
Aug. 3, 2006 (FR) 0653279

(51) Int. Cl. B23K 9/167

(52) U.S. Cl. 219/137 R

(57) ABSTRACT

The invention relates to a braze-welding or arc-welding method using a TIG torch equipped with a non-consumable electrode (1) and a consumable filler wire (2) of a given diameter, wherein the transfer of metal to the welded joint occurs in successive droplets of molten metal deposited at a frequency of between 20 Hz and 90 Hz, and the size of said drops is between 1, 2, and 4 times the diameter of the consumable wire.

The present invention relates to a process for the welding or braze-welding, preferably robotically controlled, with a TIG torch and a filler metal in the form of one or more consumable wires, in particular of one or more workpieces made of coated steel or made of aluminum or an aluminum alloy, in which the metal is transferred from the wire or wires into the weld puddle by successive droplets at a controlled frequency.

It is known from documents US-A-5 512 726 and DE-A-3 542 984 to have a conventional TIG torch configuration with a consumable wire in which the consumable wire is fed into the weld puddle horizontally or practically horizontally so as to transfer molten metal by droplets from the molten end of the consumable wire into the weld puddle, i.e. into the weld zone on the workpieces to be welded or braze-welded.

However, with such a torch, the sixth axis of the robot carrying the TIG torch is locked and its degrees of freedom are limited, given that a certain directivity is needed to orient the wire feed on the axis of the joint to be welded because of the horizontal feed of the wire.

In addition, with this type of configuration, the productivity of the process is affected by a limited rate of melting of the wire and therefore a limited welding speed.

Document EP-A-1 459 831 proposes an arc welding process that does not have the abovementioned problems. In this case, the consumable wire is fed in at an angle of less than 50°, preferably an angle between 15° and 35°, relative to axis of the electrode and the end of the consumable wire is permanently guided and held in place at a distance of less than 2 mm from the tip of the tungsten electrode.

Such a process enables good results to be achieved in most applications. However, it has been observed that, when welding or braze-welding certain particular materials, in particular coated steels, for example galvanized or electrogalvanized steels, aluminum and its alloys, weld quality problems arise, in particular bead compactness problems and/or coarse-grain microstructure problems in the melted material.

In addition, on aluminum it is not possible to obtain a bead quality, especially in terms of appearance and esthetics, equivalent to that of obtained with manual welding.

One object of the present invention is therefore to improve the process described by document EP-A-1459831 so as to obtain effective welding or braze-welding, particularly of specific materials, especially coated steels and aluminum and its alloys, so as to alleviate, minimize or at least reduce the abovementioned quality problems.

The solution of the invention is a braze-welding or arc-welding process employing a TIG torch provided with a nonconsumable electrode and with a consumable filler wire of given diameter, in which:

a) the TIG torch is fed with said consumable wire in such a way that the consumable wire is fed in at an angle of less than 50° to the axis of the electrode, i.e. the axis of the end of the wire near the nonconsumable electrode and the axis of said electrode make an angle of less than 50°;

b) the end of the consumable wire is permanently guided and held in place at a distance of less than 2 mm, preferably at 1 mm as a minimum (approximately 1.5 times the diameter of the wire), from the tip of the tungsten electrode of the TIG torch; and

c) the end of the consumable wire is progressively melted by the electric arc generated between the non-consumable electrode and at least one workpiece to be welded, so as to transfer molten metal by droplets from the end of the wire to said at least one workpiece and thus obtain a welded or braze-welded joint, characterized in that the transfer of metal to the welded joint takes place by successive droplets of molten metal, said droplets being deposited at a frequency of between 20 Hz and 90 Hz, and the size of the droplets being, for these frequencies respectively, between 1.5 and 4 times the diameter of the consumable wire.

The expression “transfer by droplets” is understood to mean that metal is transferred from the end of the wire into the weld or braze puddle by successive droplets, separated from one another and therefore without permanent contact between the filler wire and the molten metal.

The solution provided by the invention therefore relies on the fact that molten metal is transferred in the form of droplets, the frequency and the size of which depend on the wire speed, on the wire-electrode distance and on the electrode-workpiece distance.

These trends and variations are indicated in Tables 1 and 2 below.

TABLE 1
Influence of the variation in wire-electrode distance

| | | |
|---|---|---|
| | Wire-electrode | Wire-electrode |
| Transfer | distance ↑ | distance ↓ |

| | | | |
|---|---|---|---|
| Transfer by | Droplet | ↓ | ↑ |
| droplets | size | | |
| | Frequency | ↑ | ↓ |
| Transfer by | | The wire “taps” | Droplet |
| liquid | | the bead | transfer V_{wire} ↑ |
| bridge | | | for liquid |
| | | | bridge transfer |

As can be seen in Table 1, for a constant wire speed (V_{wire}) and a constant electrode-workpiece distance:
as the wire-electrode distance increases, transfer takes place not in the hottest zone of the arc but in the zone between 2000 and 5000 K, the droplet size increases and the frequency decreases according to the laws presented below in the description;
conversely, as the wire-electrode distance decreases, wire transfer takes place in the hot zone of the arc, namely about 5000 and 10000 K, the droplet size decreases and the transfer frequency increases. The welding speed can therefore be increased.

TABLE 2
Influence of the variation in electrode-workpiece distance

| | Electrode- | Electrode- |
|---|---|---|
| | workpiece | workpiece |
| Transfer | distance ↑ | distance ↓ |

| | | | |
|---|---|---|---|
| Droplet | Droplet | ↑ | Change to |
| transfer | size | | liquid bridge |
| | | | transfer |
| | Frequency | ↓ | |
| Liquid | | Liquid bridge | Liquid bridge |
| bridge | | rupture: droplet | transfer: |
| transfer | | transfer | melting of the |
| | | | wire in the |
| | | | weld puddle |

As shown in Table 2, for a constant wire speed (V_{wire}) and a constant wire-electrode-workpiece distance:
as the electrode-workpiece distance increases, the droplet size increases and the frequency decreases according to the laws given below, until large droplets capable of damaging the active part of the electrode are obtained;
conversely, as the electrode-workpiece distance decreases, the droplets move into a mode of transfer in which they are almost simultaneously in connection with the wire and the weld puddle so as to exceed the thresholds for liquid bridge transfer.

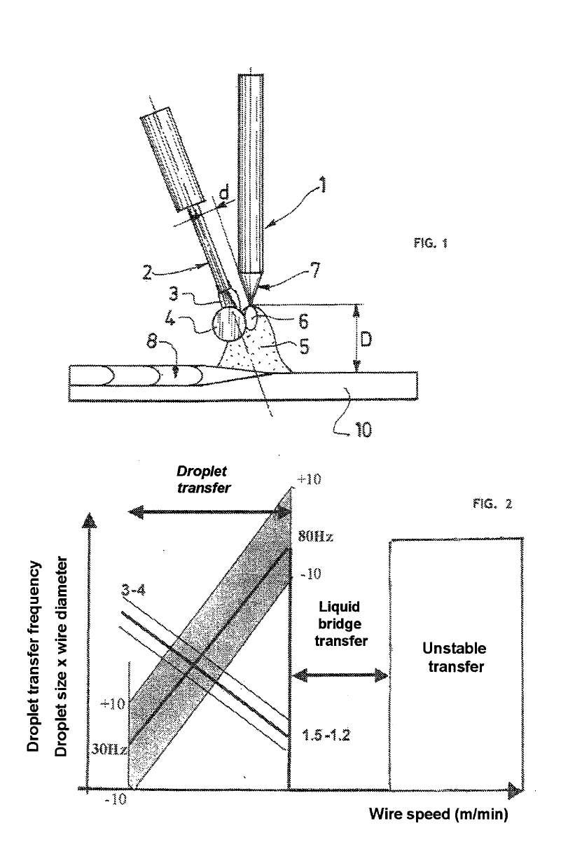

The data given in Tables 1 and 2 is shown schematically in the appended FIG. 2, which shows droplet transfer according to present invention obtained with a wire of ER308LSi stainless steel grade with a diameter of 1.2 mm, determined by:
a rather broad wire speed range (with a wire diameter of 1.2 mm) going from about 0.5 m/min to about 3.5 to 4 m/min for which a droplet transfer regime characterized by a minimum wire speed (V_{wire}) for which a mean droplet size of 3.5 times the wire diameter is associated with a transfer frequency of 20 Hz and by a maximum wire speed of 3 m/min for which a droplet size of 1.2 times the wire diameter is associated with a transfer frequency of 90 Hz is maintained;
between these two limits, the variation in droplet size (DS) and in transfer frequency (TF) is linear and may be associated with laws of the type:

TF(in Hz)=28×V_{wire}(in m/min)+6;

DS(in mm)=k×wire diameter=−0.6×V_{wire}(in m/min)+3.3.

For a given wire/gas pair, these transfer curves are to be associated with a fixed predefined wire-electrode distance and a fixed predefined electrode-workpiece distance.

For example, a procedure may be carried out as indicated in Table 3 below in order to choose the frequency and the droplet size when welding aluminum alloy test pieces of 2 mm thickness, made of two different aluminum grades, namely the 6061 and 5083 grades, for joint configurations of the lap weld, angle weld and butt weld type.

TABLE 3
Droplet transfer on aluminum

| | | 6061 Grade - 2 mm thickness | | | | | |
|---|---|---|---|---|---|---|---|
| 4043 | 1.2 | 1.5 | 2.5 | 1.3 | D | 8 | Lap |
| | | 1.5 | 2.5 | 1.3 | D | 8 | Lap |
| | | 1.5 | 2.5 | 1.3 | D | 8 | Lap |
| | | 2 | 1.5 | 1.3 | D | 10 | Angle |
| | | 2 | 2.5 | 1.7 | D | 14 | Angle |
| | | 2 | 2.5 | 1.7 | D | 14 | Angle |
| | | 5083 Grade - 2 mm thickness | | | | | |
| 5356 | 1.6 | 1.5 | 2 | 1.8 | D | 7 | Angle |
| | | 1.5 | 3 | 1.1 | D | 5 | Angle |
| | | 3 | 5 | 2.4 | D | 8 | Angle |
| | | 2 | 5 | 2.4 | D | 8 | Angle |
| | | 3 | 2.5 | 2.6 | D | 9 | Butt |
| | 1.2 | 2 | 2 | 0.6 | D | 11 | Butt |
| | | 2 | 2 | 0.85 | D | 12 | Butt |
| | | 2 | 2 | 1 | D | 12 | Butt |
| Filler | Diameter | Electrode/wire | Electrode/workpiece | Wire speed | Droplet | | Assembly |
| metal | | distance | distance | (in m/min) | transfer | | configuration |

Dce = distance;
D = droplet.

Table 3 above shows one way of adapting the droplet transfer according to the invention for various joint configurations and two types of aluminum alloy.

As may be seen, in the case of the 6061 material, it is recommended to use lower wire speeds in lap welding than in angle welding with reduced associated electrode-wire distances, i.e. of around 1 to 2 times the wire diameter, in order to have a reduced droplet size and a higher frequency, thereby making it possible to better control the directivity of transfer into the lap weld.

For the 5183 material, the approach remains the same between lap welding and butt welding with greater latitude in settings in butt welding with regard to the electrode/wire distance and to the wire speed, which is generally greater.

These settings for low wire speeds, i.e. less than or equal to about 1.5 m/min, especially for wires of large diameter, i.e. at least about 1.2 mm, require a suitable wire feed arrangement, for example of the push-pull type, in which the roller plate of the wire feeder unwinds the wire and the rollers of the torch control the feed.

Droplet transfer at a particular frequency according to the invention makes it possible to produce beads of attractive quality similar to those produced in manual welding, particularly on aluminum, this process enabling surface “solidification waves” to be reproduced.

Moreover, the process also makes it possible to solve problems of bead compactness and of coarse-grain microstructure of the melted metal that are encountered with the known processes.

In the case of austenitic stainless steel, the conditions for attaining droplet transfer with a 308LSi grade wire are given for comparison in Table 4.

TABLE 4
Welding of austenitic stainless steel

| | | | Wire | | | | | Welded |
|---|---|---|---|---|---|---|---|---|
| Welded | | | diameter | Voltage | Current | V_{w} | V_{wd} | thickness |
| material | Process | Gas | (mm) | (V) | (A) | (m/min) | (m/min) | (mm) |
| Stainless | Invention | ARCAL | 1.2 | 14 | 200 | 2.4 | 1 | 2 |
| steel | Prior art | 15 | | | | 1.7 | 0.6 | |

V_{w}: wire speed;
V_{wd}: welding speed.

ARCAL™15 is a commercial gas mixture from Air Liquide formed from argon and 5% hydrogen by volume.

This table 5 demonstrates the advantage of the droplet transfer of the invention compared with conventional TIG welding of the prior art, in which the melting of the wire takes place only by conduction in contact with the weld puddle. This is because transfer according to the invention makes it possible for the welding speed (V_{wd}) to be substantially increased since, with droplet transfer according to the invention, the rate at which the wire is melted is increased by its passage through the zone where the temperature is between about 5000 K and 10000 K, necessitating a 40% increase in the wire speed and consequently a 66% increase in the welding speed.

In the case of braze-welding of galvanized carbon steels, as may be seen from Table 5 below, the operating range obtaining droplet transfer remains closely linked to the nature of the wire used, namely CuAl or CuSi.

In this type of transfer, for a material thickness of 1 mm, the maximum wire speeds permit welding speeds of around 1 to 1.2 m/min.

TABLE 5
Braze-welding of galvanized carbon steels

| Welded | Thickness | | | Voltage | Current | Min. V_{w} | Max V_{w} | V_{wd} | |
|---|---|---|---|---|---|---|---|---|---|
| material | (in mm) | Gas | Wire | (V) | (A) | (m/min) | (m/min) | (m/min) | Configuration |
| Galvanized | 1 | ARCAL 1 | CuAl8 1 mm | 14 | 80 | 2 | 5.5 | 1.2 | Lap |
| (10 μm) | | | | | | | | | |
| carbon steel | | | | | | | | | |
| Carbon steel | 1 | ARCAL 10 | CuSi3 1 mm | 13 | 50 | 1 | 3.2 | | Fusion seam |

ARCAL™1 is gaseous argon sold by Air Liquide and ARCAL™10 is a commercial gas mixture from Air Liquide formed from 2.5% hydrogen by volume and argon for the remainder.

In both application cases, i.e. lap welding and fusion seam welding, the wire speed operating ranges remain sufficient, at 2 to 5.5 m/min and 1 to 3.2 m/min respectively, to be industrially exploitable.

The reason for these differences are the different natures of the alloys of the filler metals, which have different liquidus-solidus temperatures and the 10 μm coating in the case of lap welding, which demands different conditions for degassing the zinc at the interface, requiring operation with the highest possible welding speed.

In the case of the CuSi wire, the gas ARCAL™10 was used to slow down the formation of silicates on the surface of the beads.

Moreover, depending on the case, the process of the invention may comprise one or more of the following features:
the droplet transfer frequency is preferably between 30 Hz and 80 Hz;
the droplet size is from 1.5 to 3 times the diameter of the consumable wire;
the droplet transfer frequency is between 20 Hz and 40 Hz, preferably around 30 Hz, and the size of the droplets is between 3 and 4 times the diameter of the consumable wire;
the droplet transfer frequency is the result of combining a wire pulse frequency with a DC or AC current pulse frequency in the case of aluminum and its alloys (or of the variable polarity type), which allows more precise control of the welding and descaling phases;
the droplet transfer frequency is between 70 Hz and 90 Hz, preferably around 80 Hz, and the droplet size is between 1.2 and 1.5 times the diameter of the consumable wire;
welding is carried out with a wire speed ranging up to 20 m/min, in particular between 1 and 10 m/min, the wire speed being chosen according to the diameter of said wire;
the consumable wire is fed in at an angle between 10° and 30°, preferably between 10° and 20°, relative to the axis of the electrode;
the end of the consumable wire is permanently guided and held in place at a distance of less than 1.5 mm, preferably greater than 1 mm, from the tip of the tungsten electrode of the TIG torch. However, in all cases, the surface of the wire end must not come into contact with the tungsten electrode;
during welding, the electrode, the wire and the molten metal are shielded with gas;
the shielding gas used is a gas chosen from argon, helium and argon/helium mixtures with or without microadditions of nitrogen, and argon/hydrogen mixtures;
the process is implemented on a robotic welding arm carrying a nonconsumable-electrode TIG torch and means for feeding the consumable welding wire, or is implemented in manual or automatic welding;
the process is implemented for welding or brazing one or more workpieces;
the workpieces are made of coated steel, particularly galvanized or electrogalvanized steel, austenitic or ferritic stainless steel, nickel and nickel alloys and titanium and titanium alloys, and aluminum or aluminum alloys;
the DC current feeding the TIG torch is between 10 A and 400 A maximum and the voltage is between 10 V and 20 V;
the wire has a diameter of between 0.6 mm and 1.6 mm, preferably between 1 mm and 1.2 mm;
the wire is made of copper-silicon alloy (CuSi₃) or copper-aluminum alloy (CuAl8); and
the wire is also made of pure aluminum or of an aluminum alloy, for example 2000, 4000 or 5000 series alloy.

According to the present invention, some of the energy of the arc is used to melt the end of the wire at quite low wire speeds, typically around 1 to 10 m/min, which means that, per unit time, this energy will affect a longer length of wire and therefore give rise to the formation of droplets that are larger the lower the wire speed and the transfer frequency of which will also be low; and conversely, i.e. for a higher wire speed, but one below that at which a liquid bridge occurs, the droplet size will decrease and the transfer frequency will increase.

For a given wire diameter, the parameters are related by the following equation:

V_{wire}×wire cross section=droplet frequency×droplet volume

with: (mm/s)×(mm²)=(number of drops/s)×(mm³)

It is therefore easy, by adjusting the wire speed and for a given arc regime (electrical parameters and associated gas), to control/adjust the diameter and the frequency of the droplets. These various parameters may be evaluated and controlled very precisely using a high-speed video camera, i.e. for example one taking 10000 images per second.

Visually, the effect is directly perceptible on the surface of the weld bead, by the presence of regular waves called “solidification striations”.

This droplet transfer is different from that known in the prior art of conventional automatic TIG processes, in which the wire is melted by direct thermal conduction of the weld puddle and not, as in the present case, by some of the energy of the welding arc, which increases the rate of melting of said wire and the productivity of the process.

This is because comparative results show that, for the same lap weld or angle weld configuration and the same electrical parameters, the increase in deposition rate is around 40%.

The process of the invention, with droplet transfer, may be applied to the welding or braze-welding of any assembly of workpieces made of coated steel, of austenitic or ferritic stainless steel, of nickel and nickel alloys, of titanium and titanium alloys and of aluminum or alloys thereof, for which the aim is to seek or promote attractive weld conditions, especially regular striation on the surface of weld beads, or for which it is necessary to compensate for substantial preparation tolerances.

This droplet transfer entails a regular thermal cycle of the weld puddle, which may have effects on the microstructure of the weld puddle but also on the compactness of the melted metal by the mechanical effect of the droplet impacting on the weld puddle, causing agitation in the latter and thus facilitating the degassing thereof. This phenomenon is also visible and quantifiable as previously by using a high-speed video camera.

The process of the invention is particularly advantageous when welding very thin galvanized sheets, for example with a thickness of less than 1 mm, in order to promote the degassing of ZnO vapor, or in the welding of aluminum or its alloys in order to promote the degassing of H₂.

The process of the invention is preferably implemented using a torch with a consumable wire passing through the wall of the nozzle at an angle of less than 50°, in particular the torch described in document EP-A-1459831. This is because, in such a torch, the wire feed, which is incorporated into the torch, takes place at an angle of generally around 10° to 20°, for example around 150, to the axis of the nonconsumable electrode, while maintaining a short distance between the end of the wire and the tip of the tungsten electrode cone, for example a minimum of 1 mm, or a distance equal to the diameter of the filler wire.

In all cases, to obtain a transfer by droplets, as mentioned above, the end of the consumable wire is permanently guided and also maintained at a distance of less than about 2 mm from the tip of the tungsten electrode, i.e. the distance between the external surface of the consumable wire and the electrode must not exceed about 2 mm, preferably greater than 1 mm.

Droplet transfer according to the invention has the following advantages:
a point of impact beneath the arc, enabling the torch to be easily positioned;
controlled transfer by successive metal droplets directed accurately into the puddle;
an attractive appearance of the weld bead corresponding to particular desired recommendations;
gravity and surface-tension transfer facilitates positional welding;
the frequency and the size of the droplets are adjusted and monitored by relating them by the above equation to the wire speed for a given wire diameter;
production of multidirectional beads without changing the orientation of the wire at the TIG torch; and
possibility of achieving welding synergies, as in the case of the MIG/MAG welding process. The preferred wire speed is given as a function of the various parameters chosen by the operator: material to be joined, nature and diameter of the filler wire, current, shielding gas, welding speed, etc.

The invention is illustrated by the appended FIGURE, which shows schematically droplet transfer according to the invention.

More precisely, it shows a TIG welding torch with a nonconsumable electrode 1 fed with a consumable wire 2. As may be seen, the hottest part of the electric arc 6 which forms at the tip 7 of the electrode 1 enables the end 3 of the wire 2 to be progressively melted in the arc zone 5. The transfer of molten metal from the end 3 of the wire 2 into the weld puddle 8 forming the weld bead on the workpiece 10 takes place by successive droplets 4, the droplet diameter of which is between 1.2 and 4 times the diameter of the wire 2. Typically, the wire has a diameter between 0.6 and 1.6 mm. The droplet frequency is between 20 and 90 Hz. The droplet frequency is generated by pulsing the wire combined with a current pulse.

Moreover, the distance D between the tip of the electrode 1 and the surface of the workpieces to be welded is between about 2 mm and 3 mm. Moreover, the minimum distance d between the wire 2 and the surface of the electrode 1, including at its tip 7, is kept less than 2 mm but preferably greater than 1 mm.

Whatever the type of material welded, it has been found that the wire speed range for obtaining droplet transfer is wide and flexible in relation to the frequency and the size of the corresponding droplets.

The minimum wire speed (V_{w,min}) and maximum wire speed (V_{w,max}) are those to be applied in order to remain within droplet transfer. Above the maximum speed, liquid bridge transfer is reached.

The process of the invention with droplet transfer may be applied to various joint configurations: butt welding, lap welding, angle welding and flanged-edge welding, under degraded preparation conditions, such as clearances or misalignments, which this type of transfer can absorb more specifically, and finally for facing operations since the energy supplied to the filler wire and to the support material respectively is controlled.

1-13. (canceled)

14. A braze-welding or arc-welding process employing a TIG torch provided with a non-consumable tungsten electrode and with a consumable filler wire of given diameter wherein:
a) the TIG torch is fed with the consumable filler wire in such a way that the consumable filler wire is fed in at an angle of less than 50° to the axis of the electrode;
b) the end of the consumable filler wire is permanently guided and held in place at a distance of less than 2 mm from the tip of the tungsten electrode of the TIG torch; and
c) the end of the consumable wire is progressively melted by an electric arc generated between the non-consumable tungsten electrode and at least one workpiece to be welded, so as to transfer molten metal by droplets from the end of the wire to the at least one workpiece and thus obtain a welded or braze-welded joint, the transfer of metal to the welded joint taking place by successive droplets of molten metal that are deposited at a frequency of between 20 Hz and 90 Hz, and the size of the droplets being between 1.2 and 4 times the diameter of the consumable wire.

15. The process of claim 14, wherein the droplet transfer frequency is between 30 Hz and 80 Hz.

16. The process of claim 14, wherein the droplet transfer frequency is between 20 Hz and 40 Hz and the size of the droplets is between 3 and 4 times the diameter of the consumable filler wire.

17. The process of claim 16, wherein the droplet transfer frequency is around 30 Hz.

18. The process of claim 14, wherein the droplet transfer frequency is between 70 Hz and 90 Hz, and the droplet size is between 1.2 and 1.5 times the diameter of the consumable filler wire.

19. The process of claim 18, wherein the droplet transfer frequency is around 80 Hz.

20. The process of claim 16, wherein the droplet frequency is generated by synchronized pulsing of the wire with current pulses.

21. The process of claim 18, wherein the droplet frequency is generated by synchronized pulsing of the wire with current pulses.

22. The process of claim 14, wherein the consumable filler wire is fed in at an angle between 10° and 30° relative to the axis of the electrode.

23. The process of claim 20, wherein the consumable filler wire is fed in at an angle between 10° and 20° relative to the axis of the electrode.

24. The process of claim 21, wherein the consumable filler wire is fed in at an angle between 10° and 20° relative to the axis of the electrode.

25. The process of claim 14, wherein the end of the consumable filler wire is permanently guided and held in place at a distance of less than 1.5 mm from the tip of the tungsten electrode of the TIG torch.

26. The process of claim 25, wherein the end of the consumable filler wire is permanently guided and held in place at a distance greater then than 1 mm.

27. The process of claim 14, wherein during welding, the welded joint being formed and/or the tungsten electrode are provided with a gas shield consisting of a gas chosen from argon, helium and mixtures thereof, with or without the addition of nitrogen, and argon/hydrogen mixtures.

28. The process of claim 14, wherein the process is carried out in order to weld or braze one or more workpieces made of coated steel, particularly galvanized or electrogalvanized steel, or one or more workpieces made of austenitic or ferritic stainless steel, nickel or a nickel alloy, titanium or a titanium alloy, or aluminum or an aluminum alloy.

29. The process claim 14, wherein the DC current feeding the TIG torch is between 10 A and 400 A and/or the voltage is between 10 V and 20 V.

30. The process of claim 14, wherein the wire has a diameter of between 0.6 mm and 1.6 mm.

31. The process of claim 14, wherein several metal workpieces are welded together.

32. The process of claim 14, wherein facing operations are carried out by welding with controlled deposition rates and dilution.

33. A braze-welding or arc-welding process employing a TIG torch provided with a non-consumable electrode and with a consumable filler wire of given diameter, wherein:
a) the TIG torch is fed with the consumable filler wire in such a way that the consumable filler wire is fed in at an angle between 10° and 30° relative to the axis of the electrode, said consumable filler wire having a diameter of between 0.6 mm and 1.6 mm;
b) the end of the consumable filler wire is permanently guided and held in place at a distance of less than 2 mm from the tip of the tungsten electrode of the TIG torch;
c) the end of the consumable wire is progressively melted by an electric arc generated between the non-consumable tungsten electrode and at least one workpiece to be welded, so as to transfer molten metal by droplets from the end of the wire to the at least one workpiece and thus obtain a welded or braze-welded joint; and
d) the transfer of metal to the welded joint taking place by successive droplets of molten metal that are deposited at a frequency of between 20 Hz and 40 Hz and are generated by synchronized pulsing of the wire with current pulses, and the size of the droplets being between 3 and 4 times the diameter of the consumable filler wire.

34. The process of claim 33, wherein during welding, the welded joint being formed and/or the tungsten electrode are provided with a gas shield consisting of a gas chosen from argon, helium and mixtures thereof, with or without the addition of nitrogen, and argon/hydrogen mixtures.

35. A braze-welding or arc-welding process employing a TIG torch provided with a non-consumable electrode and with a consumable filler wire of given diameter, wherein:
a) the TIG torch is fed with the consumable filler wire in such a way that the consumable filler wire is fed in at an angle between 10° and 30° relative to the axis of the electrode, said consumable filler wire having a diameter of between 0.6 mm and 1.6 mm;
b) the end of the consumable filler wire is permanently guided and held in place at a distance of less than 2 mm from the tip of the tungsten electrode of the TIG torch;
c) the end of the consumable wire is progressively melted by an electric arc generated between the non-consumable tungsten electrode and at least one workpiece to be welded, so as to transfer molten metal by droplets from the end of the wire to the at least one workpiece and thus obtain a welded or braze-welded joint; and
d) the transfer of metal to the welded joint taking place by successive droplets of molten metal that are deposited at a frequency of between 70 Hz and 90 Hz and are generated by synchronized pulsing of the wire with current pulses, and the size of the droplets being between 1.2 and 1.5 times the diameter of the consumable wire.

36. The process of claim 35, wherein during welding, the welded joint being formed and/or the tungsten electrode are provided with a gas shield consisting of a gas chosen from argon, helium and mixtures thereof, with or without the addition of nitrogen, and argon/hydrogen mixtures.
